(19) United States
(12) Patent Application Publication
(10) Pub. No.: US 2021/0156402 A1
(43) Pub. Date: May 27, 2021

(54) ACCUMULATOR

(71) Applicant: EAGLE INDUSTRY CO., LTD., Tokyo (JP)

(72) Inventor: Hisao YOSHIHARA, Tokyo (JP)

(21) Appl. No.: 16/624,721

(22) PCT Filed: Jul. 24, 2018
(86) PCT No.: PCT/JP2018/027726

§ 371 Date: Dec. 19, 2019

(30) Foreign Application Priority Data
Jul. 25, 2017 (JP) 2017-143584

(51) Int. Cl. F15B 1/10; F15B 1/12

(52) U.S. Cl. CPC F15B 1/106; F15B 2201/3153; F15B 2201/3157; F15B 1/12

(57) ABSTRACT

An accumulator is provided with a communication passage which allows communication between a space inside a gas filling opening and a gas filled chamber in a state where a diaphragm contacts an opening peripheral edge of the gas filling opening and which is formed by, for example, uneven shapes provided in either or both of the diaphragm or/and the opening peripheral edge of the gas filling opening.

### CROSS REFERENCE TO RELATED APPLICATIONS

This application is a U.S. National Phase application of International Application No. PCT/JP2018/027726, filed on Jul. 24, 2018 and published in Japanese as WO2019/022080 on Jan. 31, 2019 and claims priority to Japanese Patent Application No. 2017-143584, filed on Jul. 25, 2017. The entire disclosures of the above applications are expressly incorporated by reference herein.

### BACKGROUND

### Technical Field

The disclosure relates to an accumulator and specifically relates to a diaphragm accumulator provided with a diaphragm having flexibility inside an accumulator housing. The accumulator of the disclosure is used as an on-board accumulator for automobiles, for example.

### Related Art

A diaphragm accumulator is provided with a diaphragm 41 having flexibility inside an accumulator housing 21 as illustrated in FIG. 4, for example. The accumulator housing 21 of the diaphragm accumulator 11 is provided with a gas filling opening 22 and an oil port 23. The diaphragm 41 divides the internal space of the accumulator housing 21 into a gas filled chamber 24 leading to the gas filling opening 22 and a fluid chamber 25 leading to the oil port 23.

The diaphragm 41 generally has a resin or rubber laminated structure and integrally has an outer peripheral attachment portion 42, a flexible portion 43, and a poppet attachment portion 46. The outer peripheral attachment portion 42 is held by a diaphragm holder 29 provided on the side inner surface of the accumulator housing 21. The flexible portion 43 is deformed according to a pressure fluctuation inside the accumulator housing 21. The poppet attachment portion 46 is provided in the center of the plane of the flexible portion 43.

The accumulator 11 illustrated in FIG. 4 has room for improvement in the following respects.

When a pressure fluctuation occurs inside the accumulator housing 21, the diaphragm 41 is deformed towards a pressure equilibrium point. When the pressure (liquid pressure) on the fluid chamber 25 side excessively increases, the diaphragm 41 contacts an opening peripheral edge 22a of the gas filling opening 22 as illustrated in FIG. 5. The gas filling opening 22 is closed with a stopper 30 after filling with gas and leaves a space 32 inside the stopper 30 also after the closing.

The diaphragm 41 exhibits a sealing action when contacting the opening peripheral edge 22a of the gas filling opening 22 to block the communication between the space 32 provided in the gas filling opening 22 and the gas filled chamber 24. As a result, a differential pressure occurs between the space 32 and the gas filled chamber 24, the communication between which is blocked. Then, when a large differential pressure occurs, the diaphragm 41 is broken in some cases.

In recent years, in the accumulator 11, the accumulator housing 21 having a flattened structure instead of a sphere is used in order to cope with high compression in many cases. In the accumulator housing 21 having the flattened structure, particularly the diaphragm 41 is likely to be tightly attached to the opening peripheral edge 22a of the gas filling opening 22. Therefore, in the accumulator housing 21 of this type, it has been strongly demanded to prevent the breakage of the diaphragm 41 due to the occurrence of a differential pressure.

It is an object of the disclosure to provide an accumulator capable of preventing a diaphragm from being broken when the diaphragm contacts an opening peripheral edge of a gas filling opening.

### SUMMARY

An accumulator of the disclosure is provided with an accumulator housing provided with a gas filling opening, a diaphragm having flexibility provided inside the accumulator housing to contact an opening peripheral edge of the gas filling opening in deformation accompanying a pressure fluctuation, and communication passages which allow communication between a space in the gas filling opening and the gas filled chamber in a state where the diaphragm contacts the opening peripheral edge of the gas filling opening.

### Effect

According to the disclosure, even when the diaphragm contacts the opening peripheral edge of the gas filling opening, the space in the gas filling opening and the gas filled chamber are maintained in the communication state, so that a differential pressure does not occur between the space in the gas filling opening and the gas filled chamber, and thus it can be prevented that the diaphragm is broken due to the occurrence of a differential pressure.

### BRIEF DESCRIPTION OF THE DRAWINGS

FIG. 1 is a cross-sectional view of an accumulator illustrating one embodiment.

FIG. 2A is a plan view illustrating projections provided in a diaphragm in the accumulator and FIG. 2B is a cross-sectional view thereof.

FIG. 3 is a cross-sectional view of a principal portion illustrating an operation state of the accumulator.

FIG. 4 is a cross-sectional view of an accumulator illustrated as a background art.

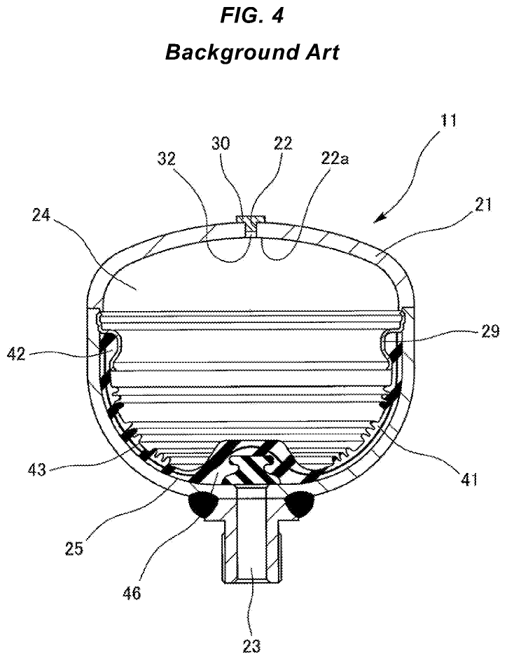

FIG. 5 is a cross-sectional view of a principal portion illustrating an operation state of the accumulator.

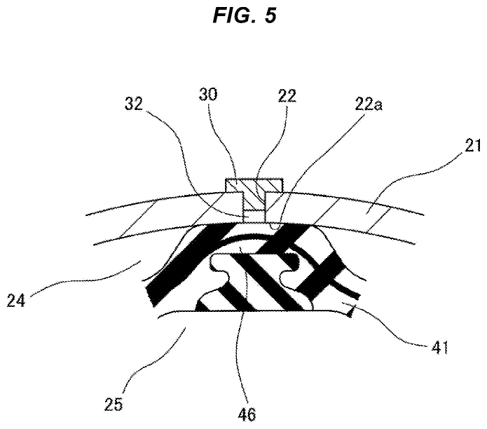

### DETAILED DESCRIPTION

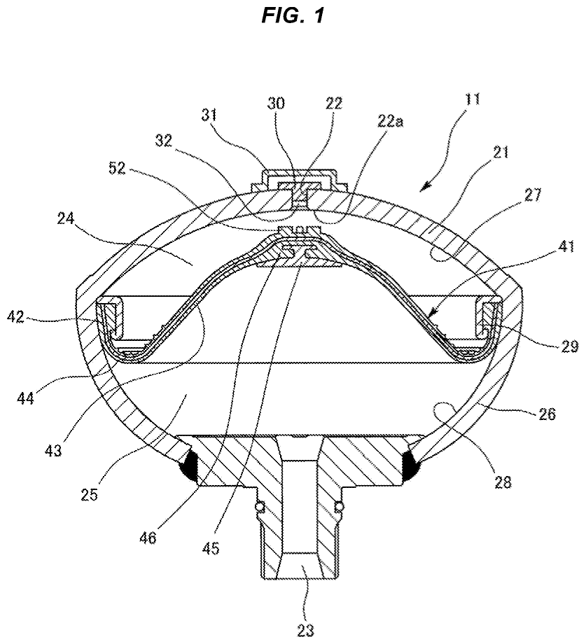

FIG. 1 illustrates an entire cross-sectional view of an accumulator 11 according to one embodiment. The accumulator 11 is a diaphragm accumulator provided with a diaphragm 41 having flexibility inside an accumulator housing 21.

The accumulator 11 has the accumulator housing 21 provided with a gas filling opening 22 and an oil port 23 on the center axis. Inside the accumulator housing 21, the diaphragm 41 is provided. The diaphragm 41 divides the internal space of the accumulator housing 21 into a gas filled chamber (gas chamber) 24 leading to the gas filling opening 22 and a fluid chamber (liquid chamber) 25 leading to the oil port 23.

The inner surface of the accumulator housing 21 has a combined shape of curved surfaces 27, 28 having a circular arc-shaped cross-section because a shell 26 is formed by drawing of a metal component. In the maximum internal diameter portion of the accumulator housing 21, an annular diaphragm holder 29 of a hook shape having an L-shaped cross-section for holding the diaphragm 41 is provided. The curved surface formed on the inner surface of the housing 21 has a combined shape of the curved surface 27 on the gas filling opening side and the curved surface 28 on the oil port side. The curved surface 27 is generated in a direction where the inner diameter dimension gradually enlarges from the gas filling opening 22 to the oil port 23. The curved surface 28 is generated in a direction where the inner diameter dimension gradually enlarges conversely from the oil port 23 to the gas filling opening 22. The curved surface 28 on the oil port side is formed by drawing from a cylindrical surface.

The gas filling opening 22 is closed with a stopper 30 after filling with gas and the outer side thereof is covered with a cover 31. Also after the closing with the stopper 30, a space 32 is provided inside the stopper 30.

The diaphragm 41 has a resin or rubber laminated structure. The diaphragm 41 integrally has an annular outer peripheral attachment portion 42, a flexible portion 43, and an annular reversing portion 44 having a substantially U-shaped cross-section. The outer peripheral attachment portion 42 is held by a diaphragm holder 29. The flexible portion 43 is deformed according to a pressure fluctuation inside the accumulator housing 21. The reversing portion 44 is provided between the outer peripheral attachment portion 42 and the flexible portion 43 and is deformed together with the flexible portion 43. The flexible portion 43 is provided with a poppet attachment portion 46, to which a poppet 45 for suppressing the protrusion of the diaphragm 41 to a through hole of the oil port 23 is attached, in the center of the plane thereof. The diaphragm 41 is also referred to as a bladder.

The surface (upper surface in the figure) on the gas filled chamber 24 side of the poppet attachment portion 46 is generally formed into a planar shape. When the surface is formed into a planar shape, the poppet attachment portion 46 contacts the opening peripheral edge 22a of the gas filling opening 22 to perform a sealing action as described above. This occurs when the pressure (liquid pressure) on the fluid chamber 25 side excessively increases in the operation of the accumulator 11. In this case, the communication between the space 32 formed by the gas filling opening 22 and the gas filled chamber 24 is blocked, so that a differential pressure may be generated in some cases.

The accumulator 11 of this embodiment is provided with communication passages 51 which allow communication between the space 32 formed by the gas filling opening 22 and the gas filled chamber 24 in a state where the diaphragm 41 contacts the opening peripheral edge 22a of the gas filling opening 22. The communication passages 51 are generated by uneven shapes, more specifically projections 52, provided in the diaphragm 41.

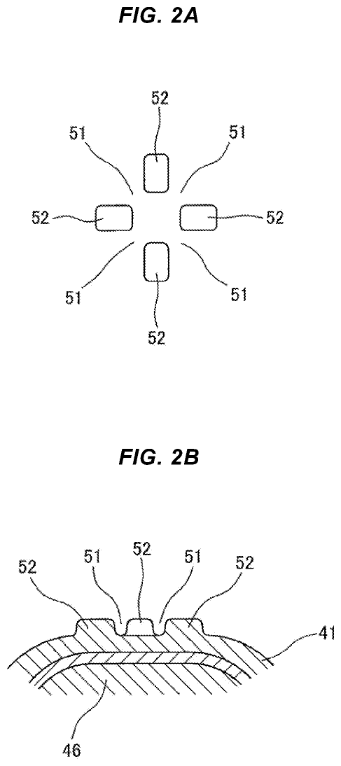

As illustrated in FIG. 2A and FIG. 2B, the diaphragm 41 integrally forms two or more of the projections 52 (four projections 52 are disposed at equal intervals in the figure) having a rib shape in a radial manner on the plane of the poppet attachment portion 46. A space between the projections 52 adjacent to each other configures the communication passage 51 which allows communication between the space 32 formed by the gas filling opening 22 and the gas filled chamber 24.

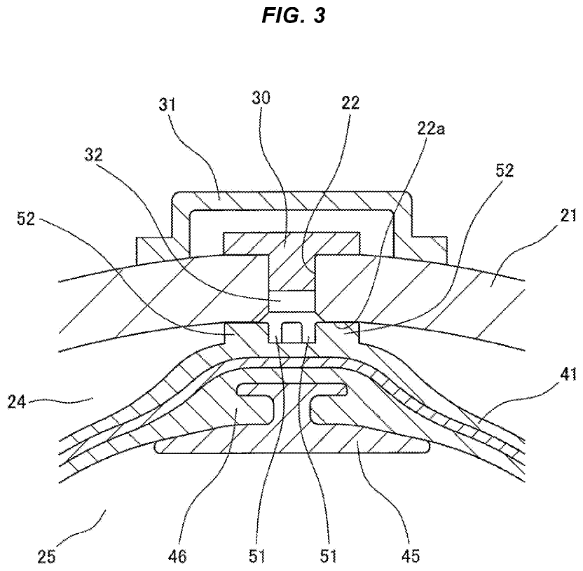

As an action, when the diaphragm 41 contacts the opening peripheral edge 22a of the gas filling opening 22, the communication passages 51 allow communication between the space 32 formed by the gas filling opening 22 and the gas filled chamber 24 as illustrated in FIG. 3. Therefore, the space 32 formed by the gas filling opening 22 and the gas filled chamber 24 maintain the communication state even when the diaphragm 41 contacts the opening peripheral edge 22a of the gas filling opening 22. As a result, the occurrence of a differential pressure between the space 32 formed by the gas filling opening 22 and the gas filled chamber 24 can be suppressed, so that it can be prevented that the diaphragm 41 is broken due to the occurrence of a differential pressure. The accumulator 11 exhibiting such an action can also cope with a flattened structure of a housing in recent years.

As another embodiment, the projections 52 provided as the uneven shapes may be provided in the opening peripheral edge 22a of the gas filling opening 22 or may be provided in both the diaphragm 41 and the opening peripheral edge 22a of the gas filling opening 22.

As still another embodiment, the uneven shape may be a groove (not illustrated) in place of the projection 52.

1. An accumulator comprising:
an accumulator housing provided with a gas filling opening;
a diaphragm having flexibility provided inside the accumulator housing to contact an opening peripheral edge of the gas filling opening in deformation accompanying a pressure fluctuation; and
a communication passage which allows communication between a space in the gas filling opening and the gas filled chamber in a state where the diaphragm contacts the opening peripheral edge of the gas filling opening.

2. The accumulator according to claim 1, wherein
the communication passage is generated by uneven shape provided in the diaphragm.

3. The accumulator according to claim 1, wherein
the communication passage is generated by uneven shape provided in the opening peripheral edge of the gas filling opening.

4. The accumulator according to claim 1, wherein
the communication passage is generated by uneven shape provided in both the diaphragm and the opening peripheral edge of the gas filling opening.

5. The accumulator according to claim 2, wherein
The uneven shape is radially provided with a plurality of uneven-shaped portions.

6. The accumulator according to claim 2, wherein
the uneven shape has a projection shape.

7. The accumulator according to claim 2, wherein
the uneven shape has a groove shape.

8. The accumulator according to claim 3, wherein
The uneven shape is radially provided with a plurality of uneven-shaped portions.

9. The accumulator according to claim 3, wherein
the uneven shape has a projection shape.

10. The accumulator according to claim 3, wherein
the uneven shape has a groove shape.

11. The accumulator according to claim 4, wherein
The uneven shape is radially provided with a plurality of uneven-shaped portions.

12. The accumulator according to claim 4, wherein
the uneven shape has a projection shape.

13. The accumulator according to claim 4, wherein
the uneven shape has a groove shape.
